(19) United States
(12) Patent Application Publication
(10) Pub. No.: US 2025/0196594 A1
(43) Pub. Date: Jun. 19, 2025

(54) RECONFIGURABLE GOLF WINDSHIELD AND MODULAR ACCESSORY MOUNTING SYSTEM

(71) Applicant: GOLF CART KING, LLC, Liberty Hill, TX (US)

(72) Inventor: Aaron Gouldie, Leander, TX (US)

(73) Assignee: GOLF CART KING, LLC, Liberty Hill, TX (US)

(21) Appl. No.: 18/982,993

(22) Filed: Dec. 16, 2024

Related U.S. Application Data
(60) Provisional application No. 63/610,716, filed on Dec. 15, 2023.

(51) Int. Cl. B60J 1/06; E05D 5/02

(52) U.S. Cl. CPC B60J 1/06; E05D 5/0246; E05D 2005/0261

(57) ABSTRACT

Apparatus and associated methods relate to a modular accessorial windshield hinge for attaching to a vehicle body. The reconfigurable windshield and modular accessory mounting device includes a frame extending along a longitudinal direction configured to receive opposing members. The reconfigurable windshield and modular accessory mounting device includes a hinge having a first member pivotally coupled to a second member, the first member and second member each configured to couple to and support respective portions of a folding windshield. The reconfigurable windshield and modular accessory mounting device includes a mounting member fixedly coupled to at least of the first and second member wherein the mounting member is configured to releasably couple one or more modular accessories to the windshield. Various embodiments may advantageously couple modular accessories to operable windshield frames. The modular accessorial windshield hinge advantageously includes an operational mode. The modular accessorial windshield hinge advantageously includes a stowage mode.

### CROSS-REFERENCE TO RELATED APPLICATIONS

This application is a continuation-in-part and claims the benefit of U.S. Design Application Serial No. 29,925,215, titled “Windshield Hinge,” filed by Aaron Gouldie on Jan. 23, 2024.

This application also claims the benefit of U.S. Application Ser. No. 63/610,716, titled “Reconfigurable Golf Windshield and Modular Accessory Mounting System,” filed by Aaron Gouldie on Dec. 15, 2023.

This application incorporates the entire contents of the foregoing application(s) herein by reference.

### BACKGROUND

Motor vehicles combine internal combustion or electric engines with transmission systems for propulsion. Integrated electronic controls optimize performance and emissions. Hydraulic brakes ensure safety, while suspension systems offer comfort. Advanced vehicles feature driver-assistance technologies like automatic braking and lane-keeping, powered by sensors and onboard computers for navigation and entertainment.

Vehicle window frames, made from materials like steel, aluminum, or reinforced polymers, are engineered to hold glass or advanced polycarbonate panes. These frames ensure the stability and movement of windows, contributing to aerodynamics and noise reduction. The design incorporates sealing systems for weatherproofing and minimizes vibrations. Some frames also integrate thermal or acoustic insulation, enhancing comfort and safety within the vehicle's cabin.

Vehicle accessories enhance functionality, comfort, and style. They include GPS navigation systems, audio upgrades, custom seat covers, floor mats, and phone mounts for convenience. For aesthetics, there are decorative decals and ambient lighting. Performance enthusiasts often add custom exhausts, suspension kits, and performance tires, tailoring the vehicle to personal preferences and needs.

### SUMMARY

Apparatus and associated methods relate to a modular accessorial windshield hinge for attaching to a vehicle body. The reconfigurable windshield and modular accessory mounting device includes a frame extending along a longitudinal direction configured to receive opposing members. The reconfigurable windshield and modular accessory mounting device includes a hinge having a first member pivotally coupled to a second member, the first member and second member each configured to couple to and support respective portions of a folding windshield. The reconfigurable windshield and modular accessory mounting device includes a mounting member fixedly coupled to at least of the first and second member wherein the mounting member is configured to releasably couple one or more modular accessories to the windshield. Various embodiments may advantageously couple modular accessories to operable windshield frames. The modular accessorial windshield hinge advantageously includes an operational mode. The modular accessorial windshield hinge advantageously includes a stowage mode.

Various embodiments may achieve one or more advantages. For example, some embodiments may allow a user to rotate a top segment of the frame. Some embodiments may, for example, allow a user to fasten the coupling points to a vehicle (e.g., magnetically, elastically, adhesively, structurally with fasteners). Some embodiments may, for example, allow a user to couple accessories to their vehicles, such as cupholders, mirrors, messaging, fans, loudspeakers, and/or phone holders. Vehicles may, for example, vehicles with window visors. The vehicles may, for example, include golf carts, off road vehicles, all-terrain vehicles, and/or some motor bikes.

The details of various embodiments are set forth in the accompanying drawings and the description below. Other features and advantages will be apparent from the description and drawings, and from the claims.

### BRIEF DESCRIPTION OF THE DRAWINGS

FIG. 1 depicts a reconfigurable windshield and modular accessory mounting system employed in an illustrative use-case scenario.

FIG. 2 depicts a magnetic accessory mounting system employed in an illustrative use-case scenario.

FIG. 3A depicts the reconfigurable golf windshield and modular accessory mounting system including a dual insert system.

FIG. 3B depicts the reconfigurable golf windshield and modular accessory mounting system including a dual insert system.

FIG. 4 depicts a rear view of the rear reconfigurable golf windshield and modular accessory mounting system.

FIG. 5 is a front view of the open reconfigurable golf windshield and modular accessory mounting system.

FIG. 6 is a front view of the closed reconfigurable golf windshield and modular accessory mounting system.

FIG. 7 is a rear view of the open reconfigurable golf windshield and modular accessory mounting system.

FIG. 8 is a left view of the closed reconfigurable golf windshield and modular accessory mounting system.

FIG. 9 is a left view of the open reconfigurable golf windshield and modular accessory mounting system.

FIG. 10 is a right view of the closed reconfigurable golf windshield and modular accessory mounting system.

FIG. 11 is a right view of the open reconfigurable golf windshield and modular accessory mounting system.

FIG. 12 is a top view of the closed reconfigurable golf windshield and modular accessory mounting system.

FIG. 13 is a bottom view of the open reconfigurable golf windshield and modular accessory mounting system.

FIG. 14 is a top view of the open reconfigurable golf windshield and modular accessory mounting system.

FIG. 15 is a bottom view of the open reconfigurable golf windshield and modular accessory mounting system.

FIG. 16 is a front perspective view of the closed reconfigurable golf windshield and modular accessory mounting system.

FIG. 17 is a rear perspective view of the closed reconfigurable golf windshield and modular accessory mounting system.

FIG. 18 is a front perspective view of the open reconfigurable golf windshield and modular accessory mounting system.

FIG. 19 is a rear perspective view of the open reconfigurable golf windshield and modular accessory mounting system.

FIG. 20 is a front perspective view of a closed reconfigurable golf windshield and modular accessory mounting system with a rear-view mirror accessory.

FIG. 21 is a rear perspective view of the closed reconfigurable golf windshield and modular accessory mounting system.

FIG. 22 is a

Like reference symbols in the various drawings indicate like elements.

### DETAILED DESCRIPTION OF ILLUSTRATIVE EMBODIMENTS

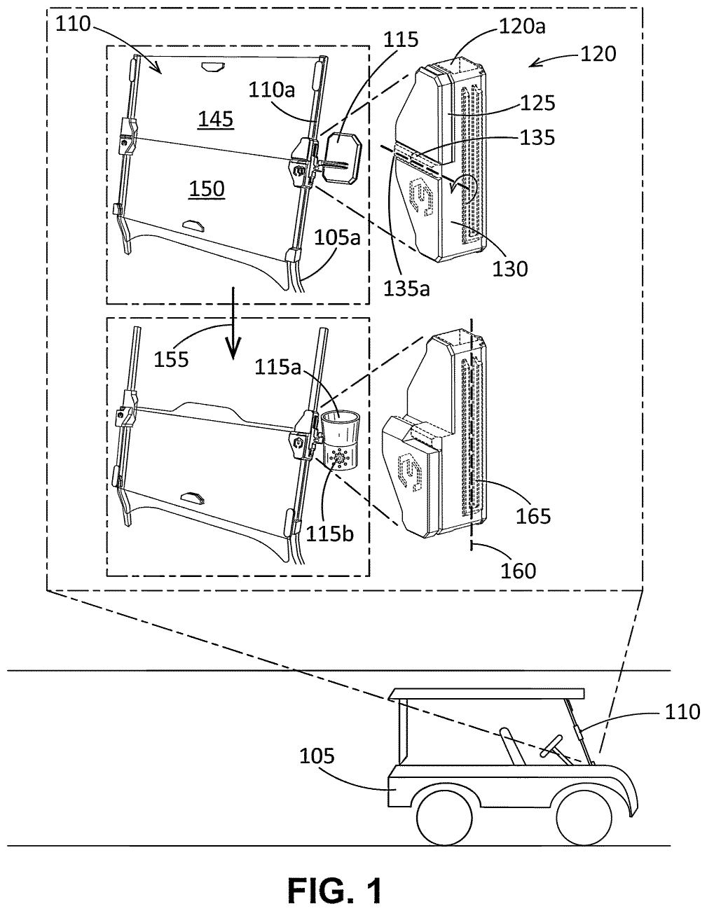

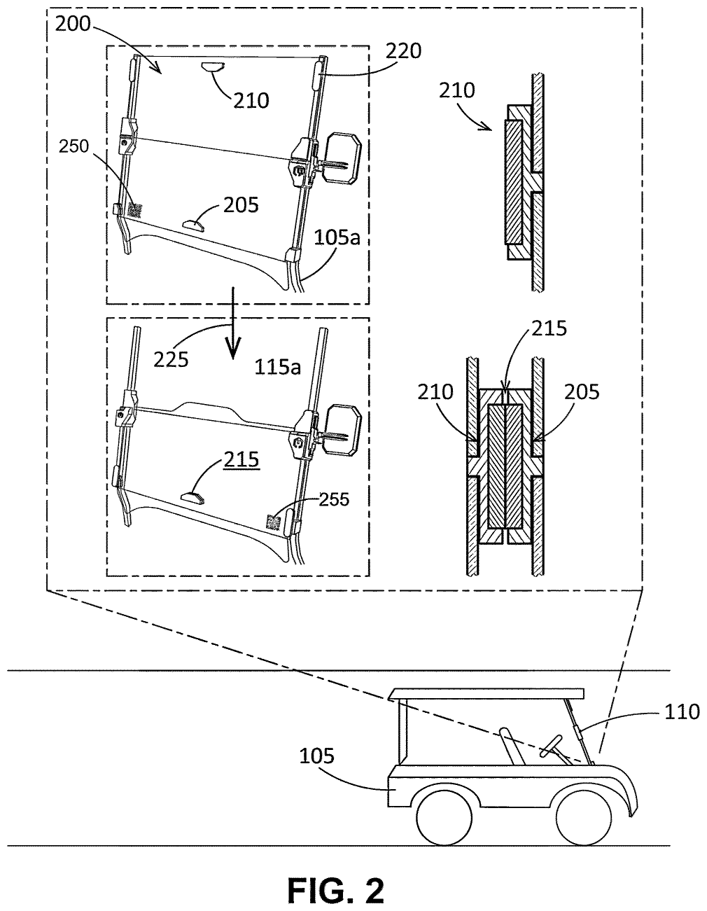

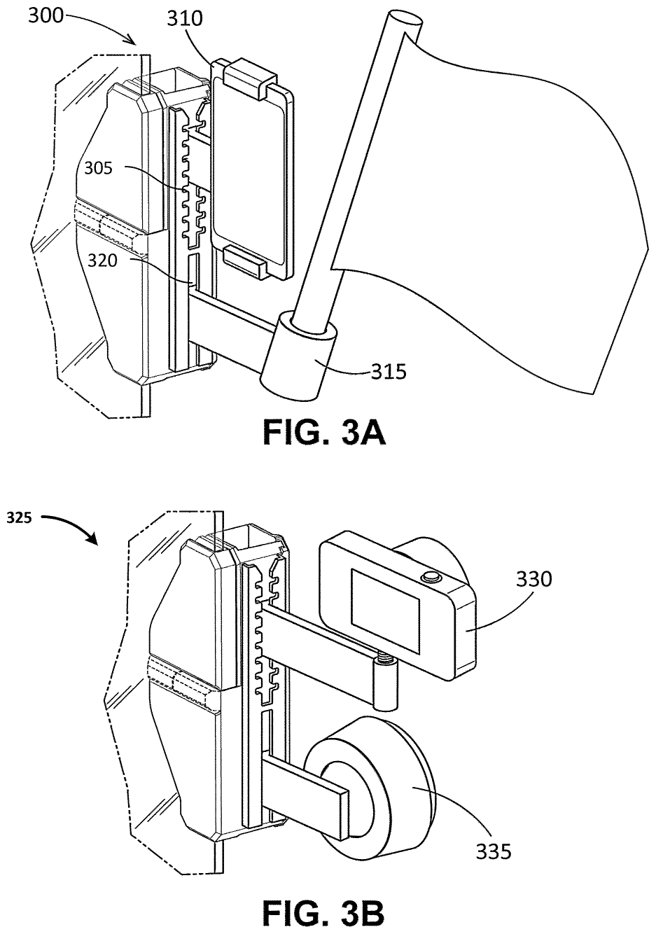

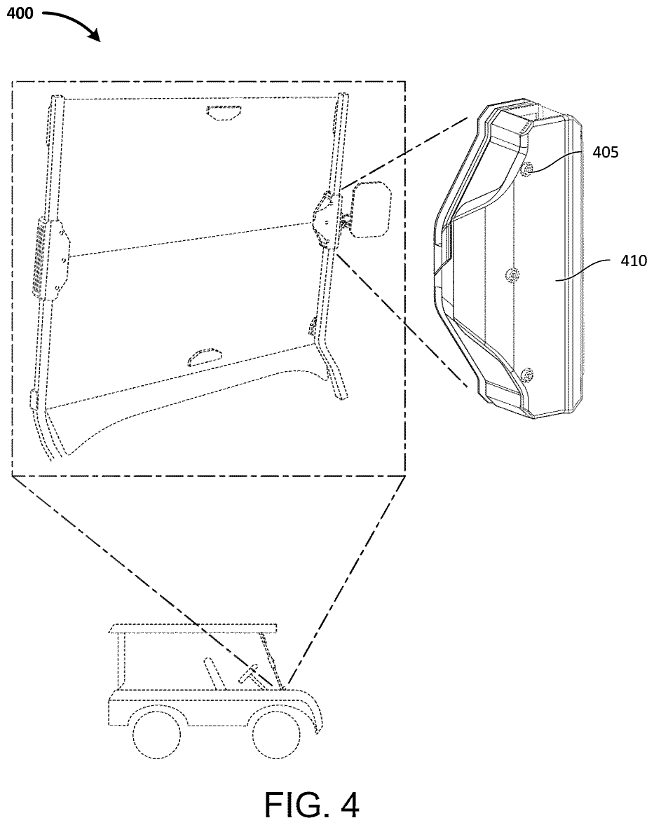

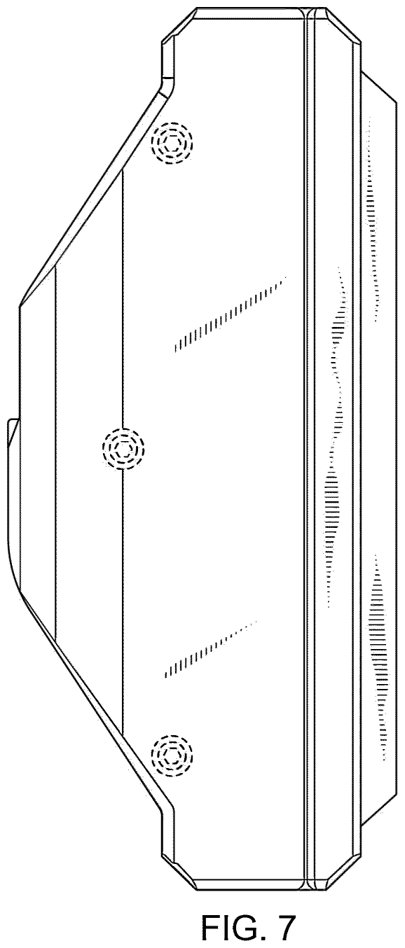

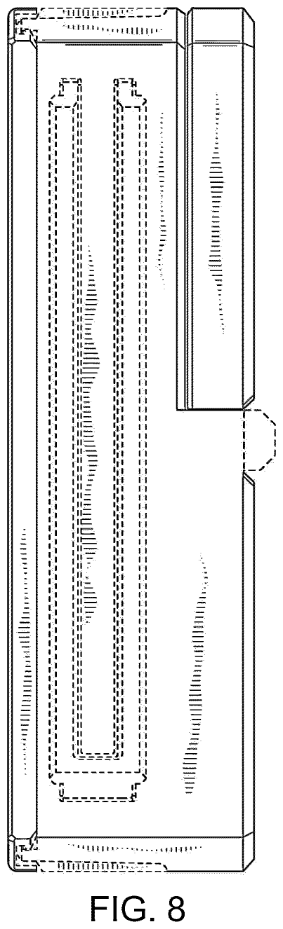

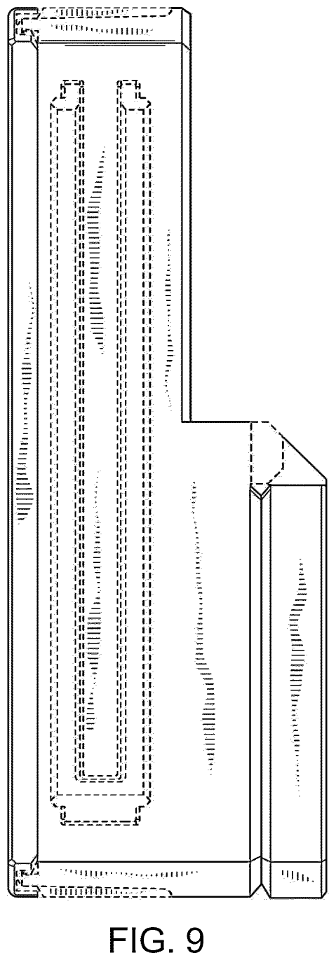

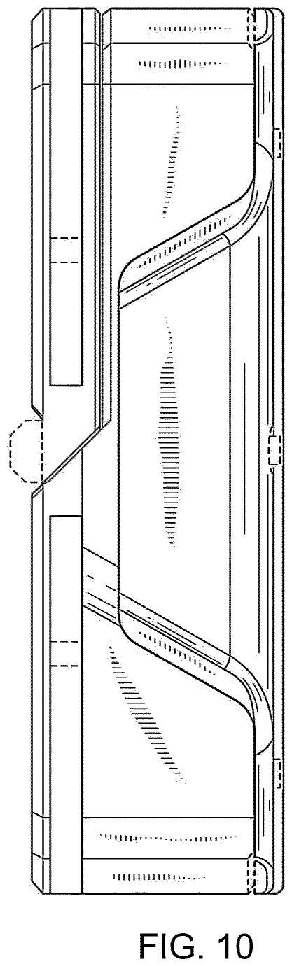

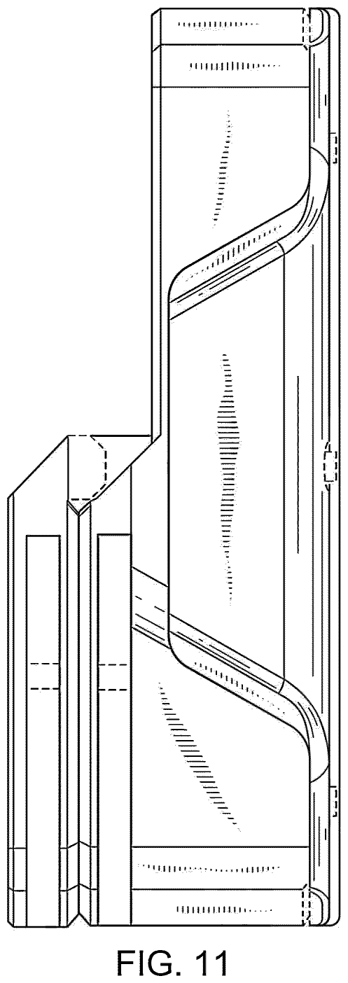

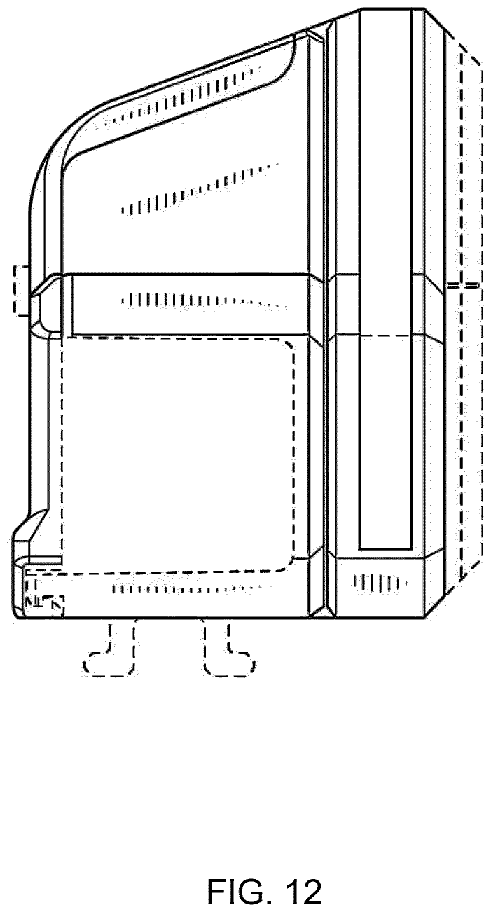

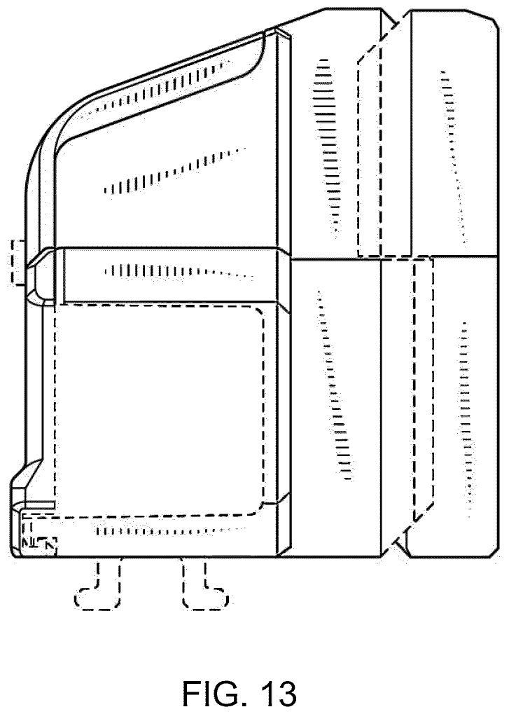

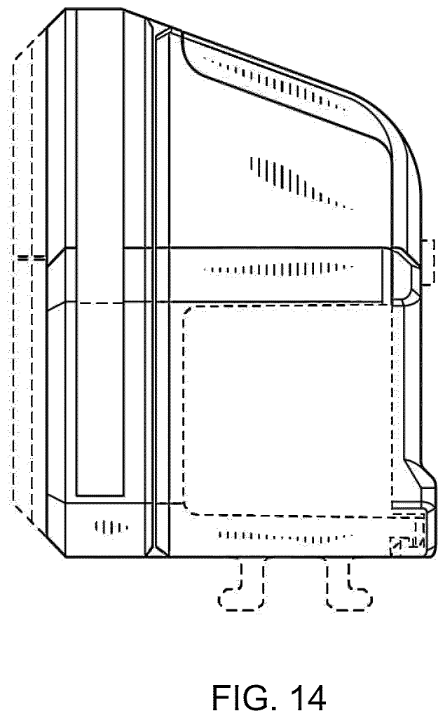

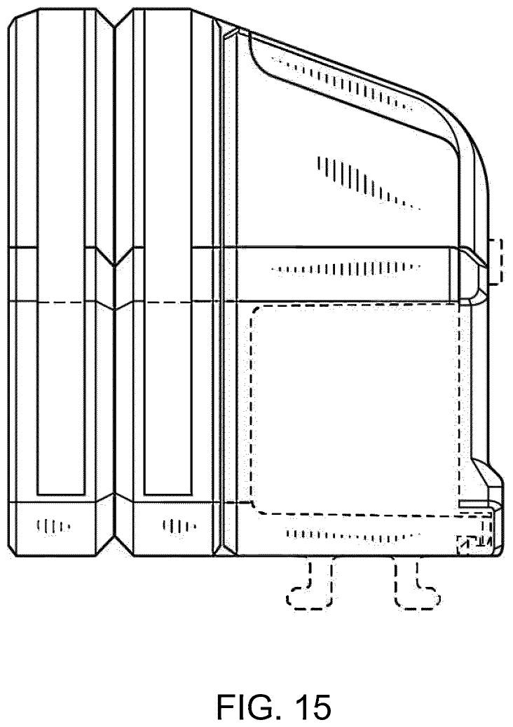

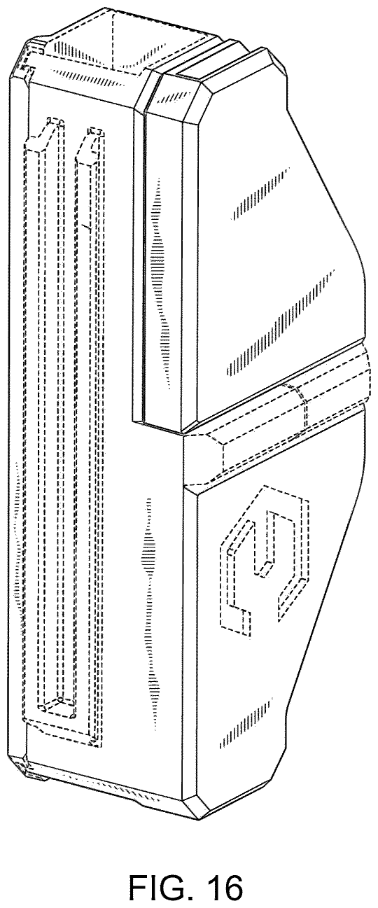

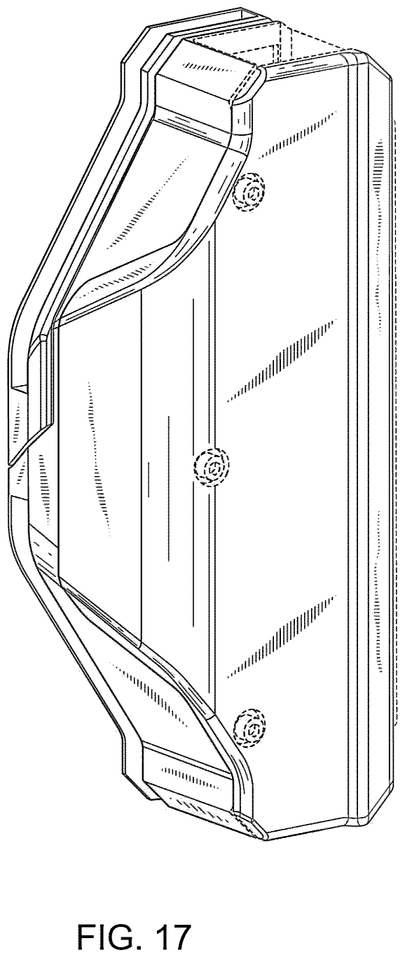

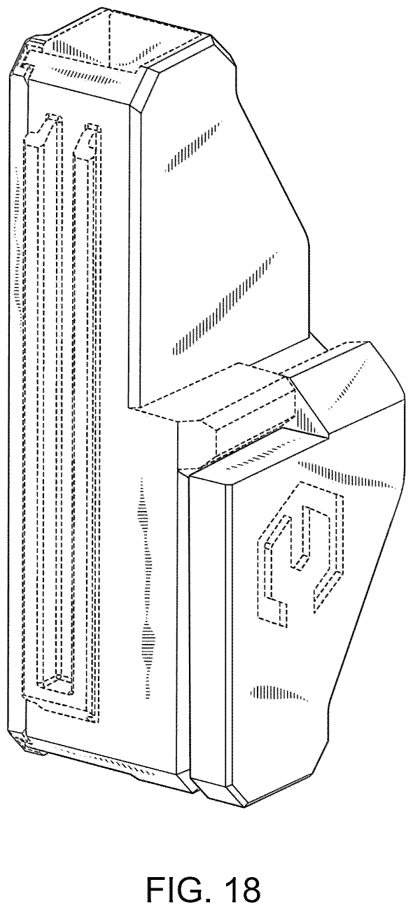

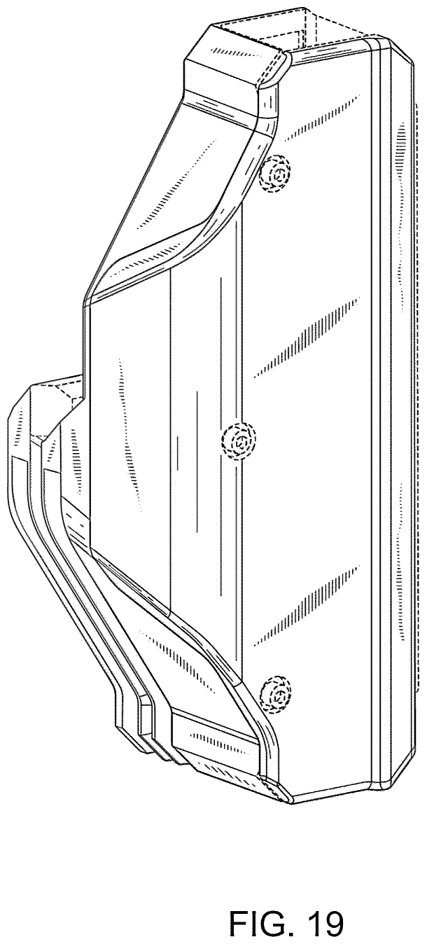

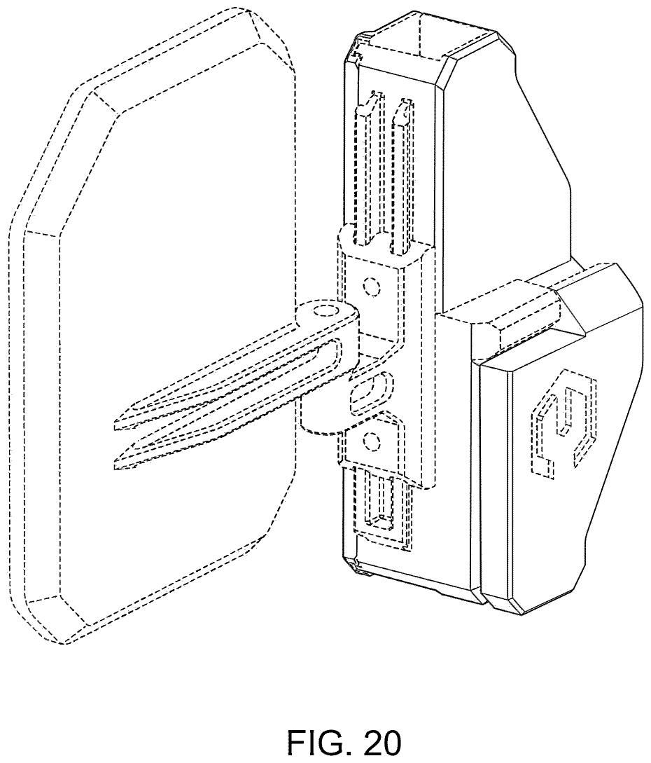

To aid understanding, this document is organized as follows. First, to help introduce discussion of various embodiments, an exemplary modular frame and modular accessory device in an illustrative use-case scenario in FIG. 1. Second, with reference to FIG. 2 an exemplary magnetic accessory mounting system is discussed. Third, with reference to FIG. 3 an exemplary multi insert embodiment is discussed with reference to the exemplary modular frame and modular accessory device. Fourth, with reference to FIGS. 7-21 the exemplary modular frame and modular accessory device is discussed and depicted in a closed and open mode.

FIG. 1 depicts an exemplary modular accessory mounting device and modular frame employed in stowage and usage mode in an illustrative use-case scenario 100. The illustrative use-case scenario includes a vehicle 105. The vehicle depicted is a golf cart.

In some embodiments, the modular accessory mounting device and modular frame may, for example, be used in other vehicles including all-terrain vehicles. The vehicles may, for example, include some motor bike embodiments. The vehicles may, for example, include water jet skis. The vehicles may, for example, include boats. The vehicles may, for example, include gliders. The vehicles may, for example, include some raft embodiments.

The vehicle 105 includes support members 105a. The support members 105a are coupled to a modular screen frame 110. The modular screen frame 110 includes a modular accessory mounting device 120.

The modular screen frame 110 includes frame insert members 110a. The frame insert members 110a are inserted into a modular screen frame aperture 120a. The modular screen frame aperture may, for example, be square. The modular screen frame aperture may, for example, be circular. The modular screen aperture may, for example, be round. The modular screen aperture may, for example, be rectangular. The modular screen aperture may, for example, be polygonal. The modular screen aperture may, for example, be an irregular shape.

The modular screen frame 110 may, for example, be releasably coupled to one accessory 115. Multiple accessories may, for example, be attached at the same time to the modular screen frame. Two accessories may, for example, be coupled as inserts to the modular screen frame. The accessories may, for example, be slid on to the modular screen frame. In some embodiments, the accessories may, for example, be clipped on to the modular screen frame. In some embodiments, the accessories may, for example, be releasably coupled to the modular screen frame. The accessories may, for example, include rear view mirrors. The accessory may, for example, include one or more speakers.

The accessory may, for example, include one or more holders. The holder may, for example, include cup holders. The holders may, for example, include mounts. The accessory may, for example, include a holder for sunglasses. The holder may, for example, include an ashtray. The holder may, for example, include an ashtray for cigars. The accessory may, for example, include a holder for phones. The accessory may, for example, include a holder for cameras (e.g., video camera, phone camera, go pros, etc.).

The accessory may, for example, be positioned along the perimeter of the modular screen frame. The accessory may, for example, be positioned to extend along the hinge while affixed to a slide. In some embodiments, two or more accessories may, for example, extend along the hinge while affixed to the slide.

The modular accessory mounting device includes an upper windshield coupler 125. The modular accessory mounting device 120 includes a lower windshield holder 130. The modular accessory mounting device 120 includes a hinge 135. The hinge 135 includes an axis of rotation 135a. The upper windshield coupler 125 may, for example, rotate along the motion 135a. The lower windshield coupler 130 may, for example, remain relatively stationary as the upper windshield coupler rotates. The lower windshield coupler 130 couples to the lower windshield 150.

The modular screen frame includes opposing modular accessory members positioned to couple to the upper windshield segment and the lower windshield while being couple to their respective frame insert members.

The hinge may, for example, have two interdigitating members. In some embodiments, the hinge may, for example, have two or more interdigitating members. In some embodiments, the hinge may, for example, include a rotatable single member and a bolt.

The hinge 135 may, for example, be operable between a stowage mode and a deployed mode. The hinge in a deployed mode may, for example, transition in a transition state 155 to a stowage mode. The opposing upper windshield couplers may, for example, affix to the upper windshield 145. The hinge may, for example, rotate between two predetermined points to deploy in the stowage mode and the deployed mode.

In some embodiments, the opposing windshield couplers may, for example, releasably couple to the upper windshield. The upper windshield may, for example, rotate along the axis of rotation of the hinge 135a. In some embodiments, the upper windshield may, for example, include an affixed mode. In some embodiments, the upper windshield may, for example, slide over the lower windshield. In some embodiments, the upper windshield may, for example, slide over the lower windshield in a motorized embodiment. Some embodiments of the modular accessory mounting system may, for example, be motorized.

In some embodiments, the modular accessory mounting system may, for example, include a locking device and/or switch. The locking device may, for example, be located on the hinge to fix the screen into a deployed and/or stowage mode. The locking device may, for example, be magnetic. The locking device may, for example, include hook and loop material (e.g., Velcro). The locking device may, for example, include magnets, snaps, clasps, and/or bolts.

Some embodiments of the modular accessory mounting device may, for example, include a hinge back cover. The side of the modular accessory mounting device 120 may, for example, include an insert module 165. The insert module may, for example, include a slider device extending along the longitudinal direction 160. The insert module 165 may, for example, extend along the longitudinal direction 160 of the modular accessory mounting device 120.

In some embodiments, the exemplary modular accessory mounting device may, for example, include an insert device. The insert device may, for example, include a fastener. The insert device may, for example, include at least one insert. The insert device may, for example, include two inserts. The insert device may, for example, include a first insert. The insert device may, for example, include a second insert.

For example, the insert device 115a may, for example, include a cup holder. For example, the insert device 115b may, for example, include a speaker. The speaker and cup holder devices may, for example, be releasably coupled together on a single modular accessory mounting device 120.

In some embodiments, a user may, for example, operate two or more different accessories at the same time from the same mount. A user may, for example, couple a video camera (e.g., go pro, phone, tablet), and a cup holder. A user may, for example, couple a cup holder and a speaker. A user may, for example, couple a messaging and a cup holder. A user may, for example, couple a messaging and a speaker at the same time to the exemplary modular accessory mounting system.

FIG. 2 depicts a magnetic accessory mounting system employed in an illustrative use-case scenario 200. The illustrative use-case scenario 200 depicts the modular screen frame including frame insert members including coupling points 220. The coupling points may, for example, be a rubber. The coupling points may, for example, include an elastic material. The coupling points may, for example, be plastic. The coupling points may, for example, include metallic material. The coupling points may, for example, include releasably coupling material (e.g., Velcro).

The illustrative use-case scenario 200 depicts an upper middle portion of the top window screen including magnetic coupling point 210. The magnetic coupling point may, for example, include magnets enclosed by a material. The material enclosing the coupling points' magnets may, for example, include rubber.

The illustrative use-case scenario 200 depicts the lower modular screen frame including an opposing mid-section 205. The opposing mid-section may, for example, be manufactured of ferrous material. The illustrative use-case scenario 200 depicts a transition state 225, wherein the upper modular frame stows itself onto the lower modular frame. The transition state may, for example, include a folding function. In some embodiments, the transition state may, for example, include a sliding function. The opposing mid-section 205 and the magnetic coupling point may, for example, be magnetically coupled by magnetic forces 215.

In some points the coupling may, for example, be performed by other fastener devices including Velcro and/or clasps. The coupling points may, for example, be aligned on the exterior frame insert members. The coupling points may, for example, fold onto itself, in the stowage mode.

In some embodiments, the modular screen flame may, for example, include a lower locking device. The lower locking device may, for example, function when a portion of the device rotates to structurally stow the modular screen frame. The lower locking device may, for example, function when the portion of the device rotates to structurally lock the device into a deployed mode along a top frame of a vehicle.

FIG. 2 depicts an exemplary QR code 250. The QR code may, for example, be placed at the bottom left of the window screen as depicted in top image of close up. FIG. 2 depicts an exemplary QR code 255. The QR code may, for example, be placed at the bottom right of the window as depicted in bottom image of close up.

In some embodiments, a QR code embedded at the bottom of the windshield screen may, for example, provide quick access to essential resources, such as installation guides, product manuals, and software updates for integrated accessories like Bluetooth cameras and/or remote-controlled mirrors.

The QR code may, for example, be used to connect users to customization tools, warranty details, and/or customer support, ensuring a seamless user experience. The QR code may, for example, enable pairing of smart accessories, offer maintenance tips, and/or links to community forums for sharing configurations and feedback, enhancing both functionality and user engagement.

In some embodiments, QR codes on the modular windshield system may, for example, link users to digital menus showcasing accessory options, product catalogs, and/or customization tools. Scanning a code may, for example, allow users to browse and purchase accessories like Bluetooth cameras or cup holders, place online orders for replacement parts, and/or explore add-ons directly from their smartphones, streamlining the buying process and enhancing user convenience.

In some embodiments, a QR code placed on the system could link users to local food delivery and/or pickup options, allowing them to browse menus and order meals directly from their location. In some embodiments, the QR code could connect users to service providers such as golf cart maintenance, cleaning, and/or accessory installation services.

FIG. 3A-3B depict releasable locking devices of some modular accessory mounting device. FIG. 3A depicts an illustrative use-case scenario 300. The illustrative use-case scenario 300 includes a locking device 305 of another modular accessory embodiment. Some locking devices may, for example, include a grooved locking device. In some devices, the locking device may, for example, include two slots (e.g., an upper and lower slot). The locking device may, for example, include predetermined groove slots. A first accessory 310 may, for example, be releasably coupled to the locking device 305 in an upper slot. A second accessor 315 may, for example, be releasably coupled to a slider device 320. The first accessory 310 may, for example, include a flag mount holder 315.

FIG. 3B depicts an illustrative use-case scenario 325. The illustrative use-case scenario 325 includes a grooved locking device 325. The grooved locking device may, for example, include grooves at predetermined placements. The grooved locking device includes a first accessory 330. The first accessory 330 may, for example, include a camera 330. The grooved locking device includes a second accessory 335. The second accessory 335 may, for example, include a light device 335. The light device 335 may, for example, provide light for the camera 330.

The accessories rear windshield; slots; flag mounts; phone holders; cigar holders; lights; speakers; cup holders may, for example, be interchangeable and/or customizable.

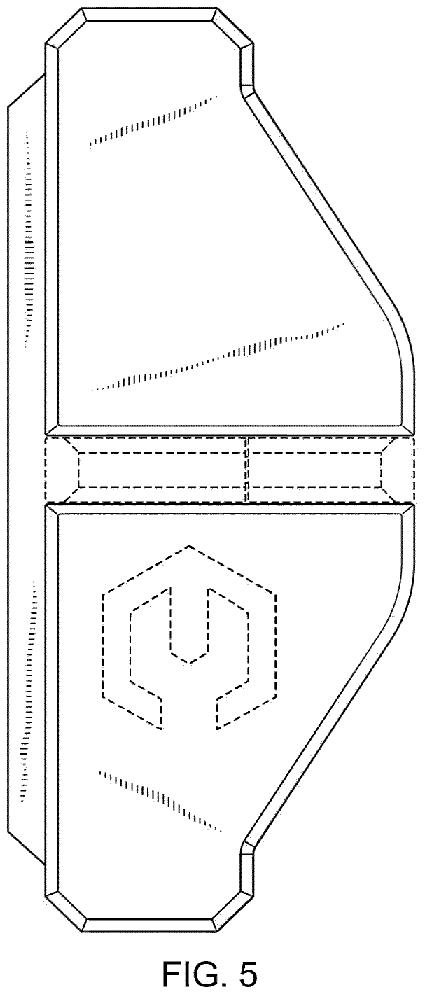

FIG. 4 depicts a rear view 400 of the rear reconfigurable golf windshield and modular accessory mounting system. The rear view 400 depicts the modular accessory mounting device backplane 410. The modular mounting device backplate may, for example, be configurable. The modular mounting device back plate may, for example, include messaging and/or graphics. The modular mounting device back place may, for example, be replicable and customizable. The modular mounting device back plate includes fasteners 405. The fasteners may, for example, include screws. In some embodiments the fasteners may, for example, be magnetic. In some embodiments the fasteners may, for example, include a clip.

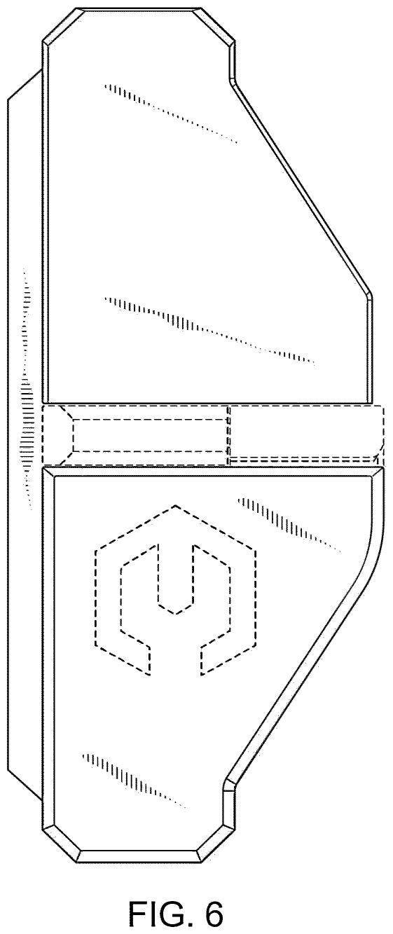

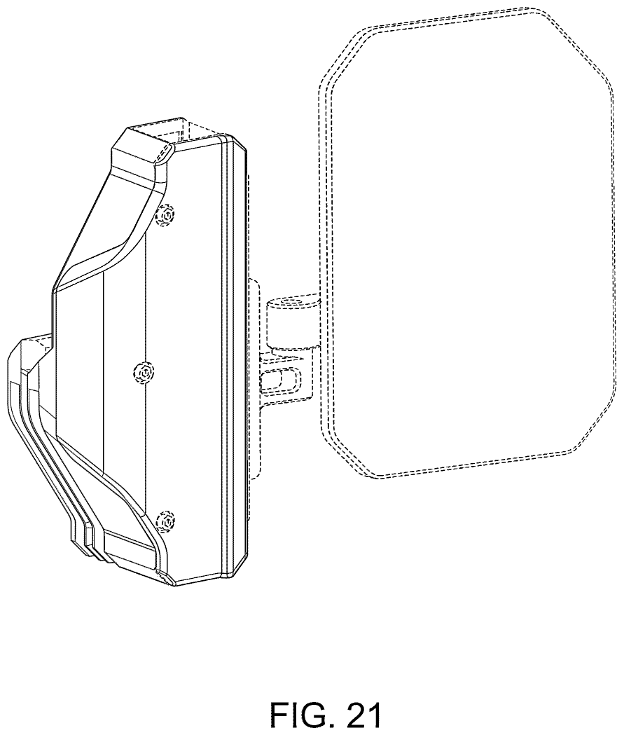

FIG. 5-21 depict several views of the open and closed reconfigurable golf windshield and modular accessory mounting device and system. FIG. 21 depicts an accessory (e.g., a rear-view mirror being releasably coupled (e.g., slid on to) the side slider.

The exemplary modular mounting device may, for example, be used in conjunction with external accessories. The exemplary modular mounting device may, for example, include a set of predetermined deployment points extending along the longitudinal axis of the exemplary mounting device. An external accessory may, for example, be insertable into the insert, and be deployed at these predetermined deployment points by entering a deployment mode. The deployment mode may, for example, be initiated by the turning of a knob, and or engaging the predetermined deployment points to couple the accessory.

In some embodiments, the hinge may, for example, frame include a top segment, allowing the top segment to rotate. In some embodiments, the hinge may, for example, be placed on the left and right side of the frame. The modular accessory mounting device may, for example, include a frame mount for the bottom segment. The bottom segment may, for example, be fixed. The bottom segment may, for example, include an elongated portion extending into the rotational path of the top segment configured to limit the rotation of the top segment past between two planes.

Some embodiments may, for example, feature a flexible, transparent material between the frames, allowing rotation while maintaining connection.

In some embodiments, the modular and collapsible frame includes coupling points. The coupling points may, for example, include an encapsulated magnet. The magnet may, for example, be enclosed by rubber to form the encapsulated magnet. The coupling points are positioned along the corners of the frame. The coupling points may, for example, be positioned to include a midpoint along each midsection of each frame.

Although various embodiments have been described with reference to the figures, other embodiments are possible.

Although an exemplary system has been described with reference to the appendixes and FIGS. 1-21, other implementations may be deployed in other industrial, scientific, medical, commercial, and/or residential applications. The modular frame and modular accessory mounting device may, for example, be used in water skis. The modular frame and modular accessory mounting device may, for example, be used in all-terrain vehicles. The modular frame and modular accessory mounting device may, for example, be used in golf carts. The modular frame and modular accessory mounting device may, for example, be used in motor bikes. Accessories may, for example, include speakers, holders, mirrors, go-pros, messaging, and/or other user accessory devices.

In some embodiments, the modular frame may, for example, be mounted onto vehicle by a sliding the accessory mount into the support members of the vehicle. The modular and collapsible screen device includes two frame segments, a top and a bottom segment. The frame segments are coupled together by a modular accessory mounting device. The modular accessory mounting device may, for example, include a hinge. The modular accessory device may, for example, include multiple inserts. Two or more accessories may, for example, be coupled to the modular accessory device at once.

Although various embodiments have been described with reference to the figures, other embodiments are possible.

In some embodiments, the modular accessory mounting device supports the attachment of multiple accessories simultaneously. The modular accessory mounting device may, for example, include a track and/or rail system allowing accessories to slide into place for secure positioning. The modular accessory mounting device may feature designated slots to prevent interference between attached items, ensuring stability. Users may, for example, align each accessory with the modular accessory mounting device's coupling points and lock them into place with a snap and/or magnetic mechanism. The modular accessory mounting device may incorporate adjustable tension elements to secure heavier or more delicate accessories effectively. The modular accessory mounting device may, for example, ensure that all attached accessories remain stable during operation, even in dynamic environments such as driving.

In some embodiments, the modular accessory mounting device may, for example, facilitate transitioning of the windshield from stowage to operational mode. The modular accessory mounting device may include a hinge with preset stops to guide the windshield into the desired position. Users may, for example, disengage the locking mechanism on the modular accessory mounting device to release the windshield from the stowage mode. The modular accessory mounting device may, for example, allow the windshield to rotate smoothly along the hinge in increments until the operational position is achieved. Once aligned, the modular accessory mounting device's locking device secures the windshield in the operational mode.

Some embodiments may, for example, not include a locking device and use the aligned magnetic coupling points prepositioned on the windshield to secure the windshield in the stowage mode, as depicted in FIG. 2.

In some embodiments, the modular accessory mounting device may, for example, allow for users to insert some accessories. Users may, for example, position the chosen accessory near the modular accessory mounting device's track and/or designated slot. The modular accessory mounting device may, for example, allow accessories to slide and/or clip into place with precision for alignment. In some embodiments, once attached, the modular accessory mounting device may, for example, lock the accessory securely using magnets and/or clasps. The modular accessory mounting device may, for example, provide adjustable slots to ensure the optimal position for each accessory.

In some embodiments, the reconfigurable windshield and modular accessory mounting system may, for example, incorporate features that leverage modern electrical and software technologies to enhance functionality and user experience. For instance, a Bluetooth-connected camera may, for example, be integrated with the modular accessory mounting device. The Bluetooth camera may, for example, enable real-time video streaming to a paired smartphone or tablet for enhanced situational awareness.

In some embodiments, a remote-controlled, articulated mirror system may, for example, allow users to adjust the angle of the mirror via a dedicated mobile application or onboard control panel, improving convenience and safety.

In some embodiments, the system may, for example, be compatible with auxiliary power inputs such as batteries, ensuring portability and functionality in remote applications.

In some embodiments, the reconfigurable windshield and modular accessory mounting device may, for example, include an adjustable tension element into the mounting member. The adjustable tension member may, for example, provide users with customizable control over accessory attachment and detachment. The tension element, which may, for example, include a spring-loaded mechanism. The tension element may, for example, include an adjustable clamp. The tension element may, for example, include a threaded knob. The tension element may, for example, allow users to modify the force needed to secure or release modular accessories based on their preferences or specific use cases. For example, a user may increase tension for accessories like mirrors or cameras to ensure stability during motion, and/or decrease it for frequently swapped items like cup holders. This feature enhances functionality by accommodating diverse user needs while ensuring a secure and reliable fit.

In various embodiments, some bypass circuits implementations may be controlled in response to signals from analog or digital components, which may be discrete, integrated, or a combination of each. Some embodiments may include programmed, programmable devices, or some combination thereof (e.g., PLAs, PLDs, ASICs, microcontroller, microprocessor), and may include one or more data stores (e.g., cell, register, block, page) that provide single or multi-level digital data storage capability, and which may be volatile, non-volatile, or some combination thereof. Some control functions may be implemented in hardware, software, firmware, or a combination of any of them.

Computer program products may contain a set of instructions that, when executed by a processor device, cause the processor to perform prescribed functions. These functions may be performed in conjunction with controlled devices in operable communication with the processor. Computer program products, which may include software, may be stored in a data store tangibly embedded on a storage medium, such as an electronic, magnetic, or rotating storage device, and may be fixed or removable (e.g., hard disk, floppy disk, thumb drive, CD, DVD).

Although an example of a system, which may be portable, has been described with reference to the above figures, other implementations may be deployed in other processing applications, such as desktop and networked environments.

Temporary auxiliary energy inputs may be received, for example, from chargeable or single use batteries, which may enable use in portable or remote applications. Some embodiments may operate with other DC voltage sources, such as a 9V (nominal) batteries, for example. Alternating current (AC) inputs, which may be provided, for example from a 50/60 Hz power port, or from a portable electric generator, may be received via a rectifier and appropriate scaling. Provision for AC (e.g., sine wave, square wave, triangular wave) inputs may include a line frequency transformer to provide voltage step-up, voltage step-down, and/or isolation.

Although particular features of an architecture have been described, other features may be incorporated to improve performance. For example, caching (e.g., L1, L2, . . . ) techniques may be used. Random access memory may be included, for example, to provide scratch pad memory and or to load executable code or parameter information stored for use during runtime operations. Other hardware and software may be provided to perform operations, such as network or other communications using one or more protocols, wireless (e.g., infrared) communications, stored operational energy and power supplies (e.g., batteries), switching and/or linear power supply circuits, software maintenance (e.g., self-test, upgrades), and the like. One or more communication interfaces may be provided in support of data storage and related operations.

Some systems may be implemented as a computer system that can be used with various implementations. For example, various implementations may include digital circuitry, analog circuitry, computer hardware, firmware, software, or combinations thereof. Apparatus can be implemented in a computer program product tangibly embodied in an information carrier, e.g., in a machine-readable storage device, for execution by a programmable processor; and methods can be performed by a programmable processor executing a program of instructions to perform functions of various embodiments by operating on input data and generating an output. Various embodiments can be implemented advantageously in one or more computer programs that are executable on a programmable system including at least one programmable processor coupled to receive data and instructions from, and to transmit data and instructions to, a data storage system, at least one input device, and/or at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, which may include a single processor or one of multiple processors of any kind of computer. Generally, a processor will receive instructions and data from a read-only memory or a random-access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including, by way of example, semiconductor memory devices, such as EPROM, EEPROM, and flash memory devices; magnetic disks, such as internal hard disks and removable disks; magneto-optical disks; and CD-ROM and DVD-ROM disks. The processor and the memory can be supplemented by, or incorporated in, ASICs (application-specific integrated circuits).

In some implementations, each system may be programmed with the same or similar information and/or initialized with substantially identical information stored in volatile and/or non-volatile memory. For example, one data interface may be configured to perform auto configuration, auto download, and/or auto update functions when coupled to an appropriate host device, such as a desktop computer or a server.

In some implementations, one or more user-interface features may be custom configured to perform specific functions. Various embodiments may be implemented in a computer system that includes a graphical user interface and/or an Internet browser. To provide for interaction with a user, some implementations may be implemented on a computer having a display device. The display device may, for example, include an LED (light-emitting diode) display. In some implementations, a display device may, for example, include a CRT (cathode ray tube). In some implementations, a display device may include, for example, an LCD (liquid crystal display). A display device (e.g., monitor) may, for example, be used for displaying information to the user. Some implementations may, for example, include a keyboard and/or pointing device (e.g., mouse, trackpad, trackball, joystick), such as by which the user can provide input to the computer.

In various implementations, the system may communicate using suitable communication methods, equipment, and techniques. For example, the system may communicate with compatible devices (e.g., devices capable of transferring data to and/or from the system) using point-to-point communication in which a message is transported directly from the source to the receiver over a dedicated physical link (e.g., fiber optic link, point-to-point wiring, daisy-chain). The components of the system may exchange information by any form or medium of analog or digital data communication, including packet-based messages on a communication network. Examples of communication networks include, e.g., a LAN (local area network), a WAN (wide area network), MAN (metropolitan area network), wireless and/or optical networks, the computers and networks forming the Internet, or some combination thereof. Other implementations may transport messages by broadcasting to all or substantially all devices that are coupled together by a communication network, for example, by using omni-directional radio frequency (RF) signals. Still other implementations may transport messages characterized by high directivity, such as RF signals transmitted using directional (i.e., narrow beam) antennas or infrared signals that may optionally be used with focusing optics. Still other implementations are possible using appropriate interfaces and protocols such as, by way of example and not intended to be limiting, USB 2.0, Firewire, ATA/IDE, RS-232, RS-422, RS-485, 802.11 a/b/g, Wi-Fi, Ethernet, IrDA, FDDI (fiber distributed data interface), token-ring networks, multiplexing techniques based on frequency, time, or code division, or some combination thereof. Some implementations may optionally incorporate features such as error checking and correction (ECC) for data integrity, or security measures, such as encryption (e.g., WEP) and password protection.

In various embodiments, the computer system may include Internet of Things (IoT) devices. IoT devices may include objects embedded with electronics, software, sensors, actuators, and network connectivity which enable these objects to collect and exchange data. IoT devices may be in-use with wired or wireless devices by sending data through an interface to another device. IoT devices may collect useful data and then autonomously flow the data between other devices.

Various examples of modules may be implemented using circuitry, including various electronic hardware. By way of example and not limitation, the hardware may include transistors, resistors, capacitors, switches, integrated circuits, other modules, or some combination thereof. In various examples, the modules may include analog logic, digital logic, discrete components, traces and/or memory circuits fabricated on a silicon substrate including various integrated circuits (e.g., FPGAs, ASICs), or some combination thereof. In some embodiments, the modules may involve execution of preprogrammed instructions, software executed by a processor, or some combination thereof. For example, various modules may involve both hardware and software.

In an illustrative aspect, a reconfigurable windshield assembly for a vehicle, the assembly may, for example, include a first windshield segment and a second windshield segment, each configured for attachment to the vehicle; and one or more encapsulated magnets integrally formed within at least one of the windshield segments, the encapsulated magnets configured to magnetically couple the first windshield segment to the second windshield segment in a secure position.

In some embodiments, the reconfigurable windshield assembly may, for example, include encapsulated magnets configured to maintain secure engagement under operating conditions.

In some embodiments, the reconfigurable windshield assembly may, for example, further include, further a reinforced frame portion disposed around the encapsulated magnets.

In some embodiments, the reconfigurable windshield assembly may, for example, further include a recessed cavity formed within at least one windshield segment to receive the corresponding one or more encapsulated magnets.

In some embodiments, the reconfigurable windshield assembly may, for example, further include a magnetically receptive accessory mount, configured to align with the encapsulated magnets such that a user can attach or reposition accessories without permanently altering the windshield segments.

In some embodiments, the reconfigurable windshield assembly may, for example, include encapsulated magnets further including a trapezoid shaped housing.

In some embodiments, the reconfigurable windshield assembly may, for example, include encapsulated magnets further including a curved housing.

In some embodiments, the reconfigurable windshield assembly may, for example, include encapsulated magnets further including polygonal housing. The reconfigurable windshield assembly may, for example, include encapsulated magnets further including an irregular shaped housing.

In some embodiments, the reconfigurable windshield assembly may, for example, include encapsulated magnets housed in a rubber material.

In some embodiments, the reconfigurable windshield assembly may, for example, include the encapsulated magnets that are housed in a silicone material.

In some embodiments, the reconfigurable windshield assembly may, for example, include encapsulated magnets housed in a polymetric material.

In some embodiments, the reconfigurable windshield assembly may, for example, include encapsulated magnets where one encapsulated magnet is affixed to the first windshield segment, and a corresponding ferrous material is affixed to the second windshield segment.

In some embodiments, the reconfigurable windshield assembly may, for example, include encapsulated magnets that are embedded in a center portion of the encapsulated magnet.

In some embodiments, the reconfigurable windshield assembly may, for example, further include encapsulated magnets that are dimensioned and arranged to facilitate a two-position configuration, a deployed mode providing a full windshield configuration and a stowed mode providing a half windshield configuration.

In some embodiments, the reconfigurable windshield assembly may, for example, include the vehicle which includes a golf cart.

In some embodiments, the reconfigurable windshield assembly may, for example, be coupled to a vehicle including an all-terrain vehicle.

In some embodiments, the reconfigurable windshield assembly may, for example, include a vehicle including an electric vehicle.

In some embodiments, the reconfigurable windshield assembly may, for example, further include a guide feature, configured to direct the first windshield segment into proper alignment with the second windshield segment.

In some embodiments, the reconfigurable windshield assembly may, for example, further include a protective coating over at least one of the windshield segments adjacent to the encapsulated magnets.

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated.

What is claimed is:

1. A reconfigurable windshield and modular accessory mounting device comprising:
a frame extending along a longitudinal direction configured to receive opposing members;
a hinge having a first member pivotally coupled to a second member, the first member and second member each configured to couple to and support respective portions of a folding windshield;
an upper and lower section windshield section, the upper windshield section pivotally coupled to a lower windshield section;
a mounting member fixedly coupled to at least one frame insert member wherein the mounting member is configured to releasably couple one or more modular accessories to the windshield; and,
at least one reconfigurable windshield and modular accessory mounting device mounted to the mounting member, wherein:
the mounting member comprises a rail device extending along a longitudinal axis intersecting a second longitudinal axis along which the hinge extends; and
the folding windshield comprises a fixed pane and a folding pane, at least one of the fixed pane and the folding pane comprising coupling points, wherein the fixed pane and the folding pane are pivotally coupled together by the hinge such that, when the folding pane is operated into a folded position, the folding pane is brought into alignment with the fixed pane at the coupling points.

2. A reconfigurable windshield and modular accessory mounting device comprising:
a frame extending along a longitudinal direction configured to receive opposing members;
a hinge having a first member pivotally coupled to a second member, the first member and second member each configured to couple to and support respective portions of a folding windshield; and,
a mounting member fixedly coupled to at least one frame insert member wherein the mounting member is configured to releasably couple one or more modular accessories to the windshield.

3. The reconfigurable windshield and modular accessory mounting device of claim 2, further comprising at least one reconfigurable windshield and modular accessory mounting device mounted to the mounting member.

4. The reconfigurable windshield and modular accessory mounting device of claim 2, further comprising at least one speaker device mounted to the mounting member.

5. The reconfigurable windshield and modular accessory mounting device of claim 2, further comprising at least one lighting device mounted to the mounting member.

6. The reconfigurable windshield and modular accessory mounting device of claim 2, further comprising at least one cup holder device mounted to the mounting member.

7. The reconfigurable windshield and modular accessory mounting device of claim 2, further comprising at least one camera device mounted to the mounting member.

8. The reconfigurable windshield and modular accessory mounting device of claim 2, wherein the mounting member comprises an upper insert accessory and a lower insert accessory.

9. The reconfigurable windshield and modular accessory mounting device of claim 2, the mounting member comprises a rail device extending along a longitudinal axis intersecting a second longitudinal axis along which the hinge extends.

10. The reconfigurable windshield and modular accessory mounting device of claim 2, further comprising an upper and lower section windshield section, the upper windshield section pivotally coupled to a lower windshield section.

11. The reconfigurable windshield and modular accessory mounting device of claim 2, wherein the folding windshield comprises a fixed pane and a folding pane, at least one of the fixed pane and the folding pane comprising coupling points, wherein the fixed pane and the folding pane are pivotally coupled together by the hinge such that, when the folding pane is operated into a folded position, the folding pane is brought into alignment with the fixed pane at the coupling points.

12. The reconfigurable windshield and modular accessory mounting device of claim 11, further comprising at least one magnetic coupling device integrated into the upper windshield section configured such that, when the folding windshield section is operated into the folding mode, then the at least one magnetic coupling device releasably secures the folding windshield section to the fixed windshield section

13. The reconfigurable windshield and modular accessory mounting device of claim 12, further comprising at least one magnetic coupling device coupled to the lower windshield section configured such that, when the folding windshield section is operated into the folding mode, then the at least one magnetic coupling device releasably secures the folding windshield section to the fixed windshield section.

14. The reconfigurable windshield and modular accessory mounting device of claim 2, wherein the mounting member comprises a track configured to slidably receive and reposition one or more modular accessories along at least a portion of the windshield.

15. The reconfigurable windshield and modular accessory mounting device of claim 2, further comprising a locking device configured to affix the hinge in at least one predetermined angular position.

16. The reconfigurable windshield and modular accessory mounting device of claim 2, wherein at least one modular accessory is magnetically coupled to the mounting member.

17. The reconfigurable windshield and modular accessory mounting device of claim 2, wherein the mounting member further comprises an adjustable tension element, configured to vary the force required to attach or detach the modular accessories.

18. The reconfigurable windshield and modular accessory mounting device of claim 2, wherein the mounting member is further provided with a predetermined number of grooves within a predetermined slot.

19. The reconfigurable windshield and modular accessory mounting device of claim 2, wherein the mounting member further comprises two slots.

20. The reconfigurable windshield and modular accessory mounting device of claim 2, further comprising at least one accessory coupled to the mounting member comprising a pivot mount configured such that the pivot mount rotates independently of the windshield.
